(19) United States
(12) Patent Application Publication
(10) Pub. No.: US 2004/0111969 A1
(43) Pub. Date: Jun. 17, 2004

(54) Opening - closing mechanism

(76) Inventor: Davut Kaya, Istanbul (TR)

Correspondence Address: LACKENBACH SIEGEL, ONE CHASE ROAD, SCARSDALE, NY, 10583, US

(21) Appl. No.: 10/474,081

(22) PCT Filed: Apr. 3, 2002
(86) PCT No.: PCT/TR02/00015

(30) Foreign Application Priority Data
Apr. 4, 2001 (TR) 2001/00949

(51) Int. Cl. E05F 11/00

(52) U.S. Cl. 49/324

(57) ABSTRACT

The opening-closing mechanism according to the present invention, consists of a bearing track (2), a spring (3) placed in said track (2), a pinion (4) providing its reciprocating movement on said spring (3); a motor drive shaft (5) providing the connection of said parts with the source of movement, a core bar (hub spindle) (6) to balance the spring (3) and two bearing bushes (7).

The present invention relates to an opening-closing mechanism that operates linearly or at different angles.

Said opening-closing mechanisms are mostly used for opening and closing the doors. Door opening mechanisms having different functions for different fields of use, are known in the state of art. These mechanisms which provide motility to the door wing, provide the opening of the door automatically, generally by cooperating with a sensor placed on the door.

In the state of art, door opening-closing mechanisms such as pneumatic, hydraulic or piston-drived mechanisms, operating by the movement of two door wings in opposite directions, are known. Such mechanisms cannot be used in door systems with wings mechanically driven for angular movements.

The object of the present invention is to develop an opening-closing mechanism that operates linearly or at different angles.

The opening-closing mechanism realized to attain the above mentioned object of the invention has been illustrated in the attached drawings, wherein;

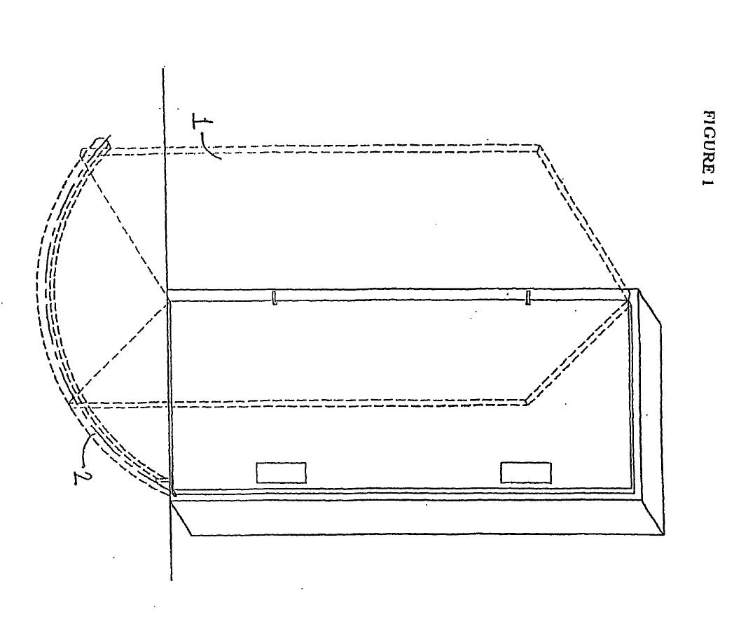

FIG. 1, is the perspective view of a door with a mechanism operated from the bottom;

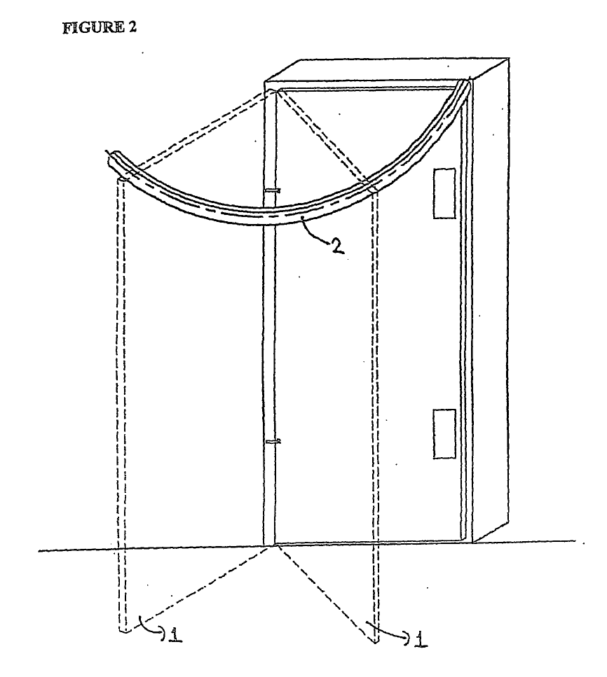

FIG. 2, is the perspective view of a door with a mechanism operated from the top;

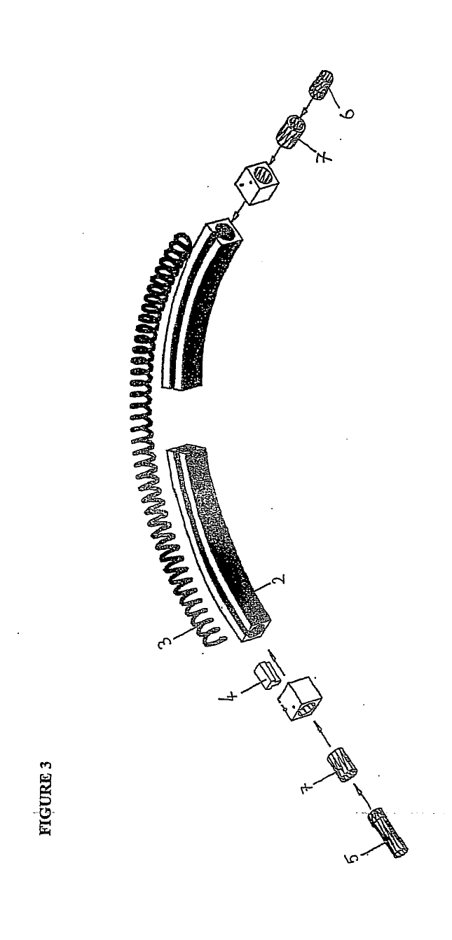

FIG. 3, is the exploded view of the door opening-closing mechanism;

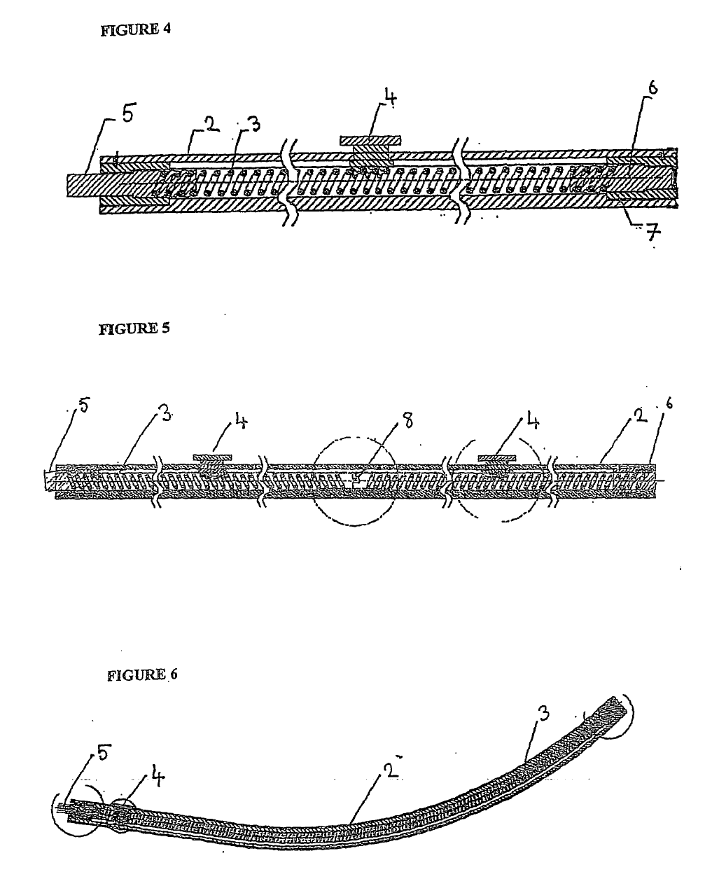

FIG. 4, is the cross-sectional view of the door opening-closing mechanism;

FIG. 5, is the cross-sectional view of the door opening-closing mechanism which consists of two pinions operating in opposite directions;

FIG. 6, is the cross-sectional view of a mechanism that operates both linearly and angularly;

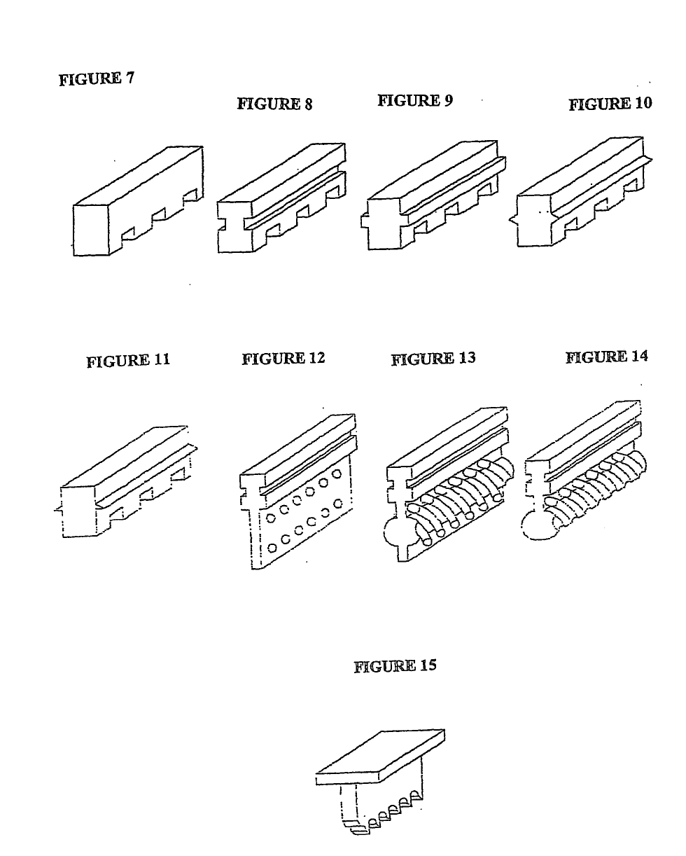

FIG. 7, is the perspective view of a flat pinion operating from exterior;

FIG. 8, is the perspective view of a pinion with an inner square section channel to outside, operating from outside;

FIG. 9, is the perspective view of a pinion with an outer square section channel to outside, operating from outside;

FIG. 10, is the perspective view of a pinion with a triangular section channel, operating form inside;

FIG. 11, is the perspective view of a pinion with a triangular section channel, vertical to outside, operating from outside;

FIG. 12, is the perspective view of a pinion with a blade and with a square section channel to inside, operating both from inside and outside;

FIG. 13, is the perspective view a convex pinion with a blade and with a square section channel to inside, operating both from inside and outside;

FIG. 14, is the perspective view of a convex pinion with a square section channel operating from inside;

FIG. 15, is the perspective view of a pinion with an annular opening operating from outside;

FIG. 16, is the sectional view of a spring with an open pitch (Step);

FIG. 17, is the sectional view of a closed and scarfed spring with a joined pitch (step);

FIG. 18, is the sectional view of a closed and scarfed spring with a joined pitch (step);

FIG. 19, is the sectional view of a open spring wound tightly around the spiral core;

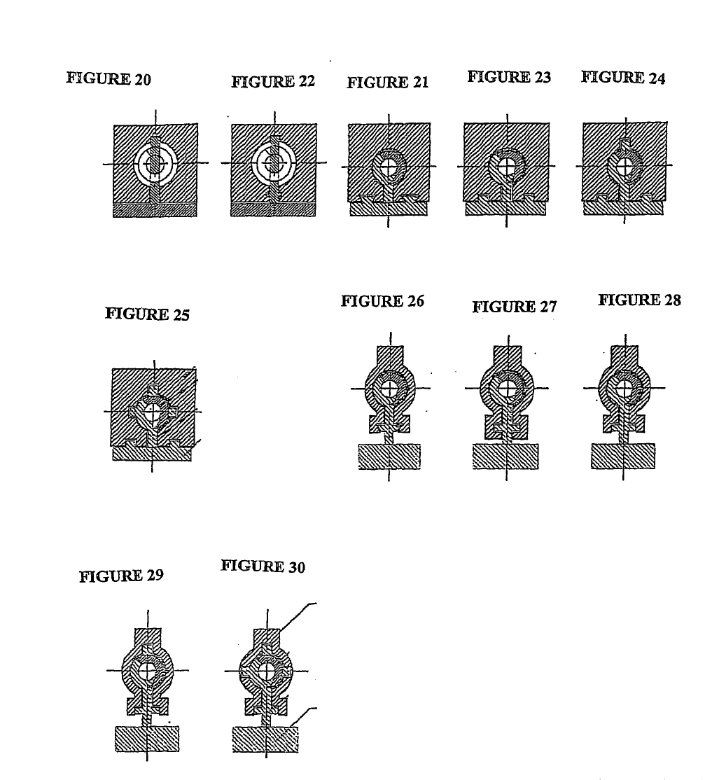

FIG. 20, is the sectional view of a bearing track with blade;

FIG. 21, is the sectional view of a bearing track with blade and channel at the neck;

FIG. 22, is the sectional view of a bearing track with triangular section channel having a pinion rail;

FIG. 23, is the sectional view of a bearing track with square section channel having a pinion rail;

FIG. 24, is the sectional view of a bearing track with blade from the track caring with square section channel having a pinion rail;

FIG. 25, is the sectional view of a the pinion and square section having a pinion rail;

FIG. 26, is the sectional view of a of the pinion with perpendicular triangular section channel

FIG. 27, is the sectional view of a bearing track with square sectioned channel at the neck;

FIG. 28, is the sectional view of a of the bearing track with square sectioned channel with blade, at the neck.

FIG. 29, is the sectional view of a bearing track with square sectioned channel, with blade at the neck,

FIG. 30, is the sectional view of a bearing track with square 3 channels at the neck.

The components shown in the drawings have been enumerated separately as follows:

1. Door Wing

2. Bearing Track

3. Spring

4. Pinion

5. Motor drive shaft

6. Core bar (hub spindle)

7. Bearing bush

8. Inter-tie shaft

The opening-closing mechanism according to the present invention, consists of a bearing track (2), a spring (3) placed in said track (2), a pinion (4) providing its reciprocating movement on said spring (3); a motor drive shaft (5) providing the connection of said parts with the source of movement, a core bar (hub spindle) (6) to balance the spring (3) and two bearing bushes (7).

The opening-closing mechanism according to the present invention, which is preferably used in door systems, may be applied at the bottom or at the top of the doorwing (1), depending on such factors as the condition of the area of usage or the intended use of the mechanism.

One of the preferred embodiments of the opening-closing mechanism operating linearly or at various angles, is a turning door.

In this embodiment, a semi-circular bearing track (2) is placed on the ground, along the circular path of the door wing, followed during its opening/closing. At one end of said bearing track (2) which is flush-mounted on the ground, the motor drive shaft (5) that transfers the power generated by the motor to the mechanism is provided and at the other end there exists a hub spindle (6) balancing the spring (3). In this embodiment, preferably a sensor is also used. This sensor, enabling the remote controlling or automatic opening of the door, contributes to the extension of the areas of usage of the mechanism according to the present invention.

When a single door-wing is used in the opening-closing mechanism according to the present invention, a certain gap is left between the lower surface of the door wing (1) and the ground. To open the door-wing in a closed position, the motor starts to run and rotates the motor drive shaft (5) to which it is connected. Said motor drive shaft (5) transfers (transmits) the movement from the motor to the spring (3) provided in the bearing track (2); which in turn causes the pinion (4) attached to the spring (3) to move inside the bearing track (2).

By virtue of a magnetic, preferably an electromagnetic component disposed on the pinion (4) a magnetic communication is provided between the pinion (4) and the door-wing (1). Thus, the movement of the pinion (4) in the bearing track (2) causes the door wing (I) to move and the door-wing (1) at the closed position may be opened. In a similar way, the door at an open position can be closed by changing the rotational direction of the motor which in turn leads to the movement of the spring (3) in the opposite direction. The movement of the door-wing (1) is limited by the length of the bearing track.

In another preferred embodiment, the opening/closing mechanism according to the invention is mounted above the door-wing. In this embodiment which is not functionally different from the ground-mounted type, said mechanism is so mounted above the door that a certain distance is left from the top surface of the door-wing (1). This system is used at regions where the mechanism of the present invention cannot suitably be mounted on the ground.

Another preferred embodiment is an opening/closing mechanism that operates by contacting with the door-wing (1) at the top. Here a pin provided on top of the door wing (1) is brought into contact with the pinion (4) attached to the spring (3) in the bearing track (2). This pinion (4), moving as shown in the other embodiments, provides the movement, opening/closing of the door-wing (1).

The opening/closing mechanism according to the present invention may also be used for the sliding door systems that open/close linearly or angularly. In the sliding-door mechanisms where both doors are movable, at least two helical springs (3) with opposite windings, which are attached to each other by means of an intertie or interties (8), are provided. At least two pinions (4) attached to said springs (3) move in opposite directions by means of a single motor drive (FIG. 5). Said pinions (4) enable the movement, opening/closing of the doors by means of a magnetic impact or by direct contact.

Another embodiment of the opening/closing mechanism of the present invention is the doors of such vehicles as busses or mini-busses. For these doors, the opening/closing mechanisms that provide both linear and angular movement, must be used and the mechanism according to the invention makes it possible, by virtue of an appropriate bearing track (2) profile (FIG. 6). Said mechanism may also be used for the closing/opening of the curtains; wherein it can easily be applied on the curtain rail and enable a smooth opening/closing of the curtains. In this embodiment which operates in a similar way as that of the sliding doors, the pinions (4) are interrelated with the rollers at the end sections of the curtain rails and as the result of the movements of said pinions (4) in opposite directions, by means of magnetic or direct contact, the rollers move in the rail; thus the curtains which are attached to the rollers, are opened or closed.

1. An opening/closing mechanism, consisting of a bearing track (2), at least one spring (3) placed in said track (2), bearing bushes (7) provided at both ends of the bearing track (2) which enable said spring (3) to be placed inside the track (2) a motor drive shaft (5) one end of which is attached to one of said bushes (7) in order to transmit movement to the spring (3) and the other end on which said spring (3) is wound, and a hub spindle (6) that serves to balance said spring (3) attached onto one of said bushes; characterized with a pinion (4) attached on the spring (3) and which moves inside the bearing track (2) when said spring (3) is driven by the motor.

2. An opening/closing mechanism as defined in claim 1, characterized with a pinion (4) that provides the opening/closing movement by means of a magnetic action, due to a magnetic part fastened on it.

3. An opening/closing mechanism as defined in claim 1, characterized with a pinion (4) that provides the movement by getting into direct contact with the object that is desired to be moved.

4. An opening/closing mechanism as defined in claims 1 to 3, characterized with a bearing track (2) that enables the linear and angular movement of the object that is desired to be moved.

5. An opening/closing mechanism as defined in claims 1 to 4 wherein the object that is desired to be moved is a door.

6. An opening/closing mechanism as defined in claims 1-4, wherein the object that is desired to be moved is a curtain rail roller.
